(19) United States
(12) Patent Application Publication
(10) Pub. No.: US 2006/0077691 A1
(43) Pub. Date: Apr. 13, 2006

(54) Light diffusion unit, display device having the same and apparatus for manufacturing the same

(76) Inventors: Dong-Hoon Kim, Seoul (KR); Jin-Sung Choi, Yongin-si (KR); Jong-Dae Park, Seoul (KR); Jae-Hwan Chun, Suwon-si (KR); Geun-Hyung Kim, Seongnam-si (KR); Min-Ho Ok, Hwaseong-si (KR); Tae-Seok Kim, Suwon-si (KR)

Correspondence Address: CANTOR COLBURN, LLP, 55 GRIFFIN ROAD SOUTH, BLOOMFIELD, CT, 06002, US

(21) Appl. No.: 11/207,451

(22) Filed: Aug. 19, 2005

(30) Foreign Application Priority Data
Oct. 8, 2004 (KR) 2004-80535
Oct. 27, 2004 (KR) 2004-86362

(51) Int. Cl. F21V 7/04

(52) U.S. Cl. 362/617

(57) ABSTRACT

In a light diffusion unit, a display device having the light diffusion unit, and an apparatus for manufacturing the light diffusion unit, the light diffusion unit includes a diffusion plate and a protruded portion. The diffusion plate has a light diffusion material that diffuses a light. The protruded portion is on the diffusion plate to guide the light diffusion unit so that a central portion of the diffusion plate has a convex shape. Therefore, an image display quality is improved.

This application claims priority to Korean Patent Application No. 2004-80535, filed on Oct. 8, 2004 and Korean Patent Application No. 2004-86362, filed on Oct. 27, 2004 and all the benefits accruing therefrom under 35 U.S.C. §119, and the contents of which in their entireties are herein incorporated by reference.

### BACKGROUND OF THE INVENTION

1. Field of the Invention

The present invention relates to a light diffusion unit, a display device having the light diffusion unit, and an apparatus for manufacturing the light diffusion unit. More particularly, the present invention relates to a light diffusion unit capable of improving an image display quality, a display device having the light diffusion unit and an apparatus for manufacturing the light diffusion unit.

2. Description of the Related Art

A liquid crystal display (“LCD”) device, in general, includes an LCD panel and a backlight assembly under the LCD panel. The backlight assembly generates a light. The LCD panel displays an image using the light.

The LCD panel includes a lower substrate, an upper substrate, and a liquid crystal layer interposed between the lower and upper substrates. The lower substrate includes a lower electrode, such as a pixel electrode. The upper substrate includes an upper electrode, such as a common electrode, and corresponds to the lower substrate. When a voltage is applied to the upper and lower electrodes, such as via gate lines and data lines formed within the lower substrate, an electric field is formed between the upper and lower substrates. Liquid crystals of the liquid crystal layer vary their arrangement in response to the electric field applied thereto. Subsequently, light transmittance of the liquid crystal layer is changed based on the arrangement of liquid crystal molecules within the liquid crystal layer to display an image.

The backlight assembly is classified as either an edge illumination type backlight assembly or a direct illumination type backlight assembly according to a position of a light source used within the backlight assembly.

The edge illumination type backlight assembly includes one or two light sources on a side or sides of a transparent light guiding plate. A light incident into a light-entering surface of the light guiding plate is reflected from a light-exiting surface of the light guiding plate toward the LCD panel positioned above the light-exiting surface of the LCD panel. The direct illumination type backlight assembly includes a plurality of light sources under the LCD panel, a diffusion plate between the light sources and the LCD panel, and a reflecting plate under the light sources. The light generated from the light sources is reflected from the reflecting plate, and diffused by the diffusion plate. The diffused light is incident into the LCD panel.

The diffusion plate contains polymethylmethacrylate (“PMMA”). The PMMA diffuses the light from the light sources so that the diffusion plate uniformizes a luminance of the light directed towards the LCD panel. The PMMA is an amorphous material so that physical characteristics of the PMMA are determined by a fluidity of its polymer chain. The fluidity is changed by heat and humidity so that a size and shape of the diffusion plate is also changed by the heat and the humidity.

When the backlight assembly includes the diffusion plate, the diffusion plate is deformed by heat generated from the light source and moisture in the air surrounding the diffusing plate. In addition, optical sheets on the diffusion plate are also deformed by the deformation of the diffusion plate. When the diffusion plate and the optical sheets are deformed, the luminance uniformity is decreased, thereby deteriorating the image display quality of the LCD device.

### BRIEF SUMMARY OF THE INVENTION

The present invention provides a light diffusion unit capable of improving an image display quality.

The present invention also provides a display device having the above described light diffusion unit.

The present invention also provides an apparatus for manufacturing the above described light diffusion unit.

The present invention also provides a method of maintaining a diffusion plate in a display device in a flat configuration having a light entering surface and a light exiting surface forming substantially planar surfaces in the diffusion plate.

A light diffusion unit in accordance with exemplary embodiments of the present invention includes a diffusion plate and a protruded portion. The diffusion plate has a light diffusion material that diffuses a light. The protruded portion is on the diffusion plate to guide the light diffusion unit so that a central portion of the diffusion plate has a convex shape.

A light diffusion unit in accordance with other exemplary embodiments of the present invention includes a diffusion plate and a first deformation preventing layer. The diffusion plate has a light diffusion material that diffuses a light. The first deformation preventing layer is formed on a light-entering surface of the diffusion plate. The first deformation preventing layer compensates a deformation of a central portion of the diffusion plate.

A display device in accordance with exemplary embodiments of the present invention includes a lamp, a light diffusion unit, and a display panel. The lamp generates a light. The light diffusion unit includes a diffusion plate having a light diffusion material that diffuses the light generated from the lamp, and a protruded portion on the diffusion plate to guide the light diffusion unit so that a central portion of the diffusion plate has a convex shape. The light diffusion unit is on the lamp. The display panel is on the light diffusion unit to display an image using the light that has passed through the light diffusion unit.

A display device in accordance with other exemplary embodiments of the present invention includes a lamp, a light diffusion unit, and a display panel. The lamp generates a light. The light diffusion unit includes a diffusion plate having a light diffusion material that diffuses the light generated from the lamp, and a first deformation preventing layer formed on the light entering surface of the diffusion plate. The first deformation preventing layer compensates a deformation of a central portion of the diffusion plate. The light diffusion unit is on the lamp. The display panel is on the light diffusion unit to display an image using the light that has passed through the light diffusion unit.

An apparatus for manufacturing a light diffusion unit in accordance with exemplary embodiments of the present invention includes an extruder, a convex-concave roller and an extending unit. The extruder extrudes a material to form a diffusion plate. The convex-concave roller is adjacent to an outlet of the extruder to form a plurality of protrusions on the diffusion plate. The extending unit extends the diffusion plate in a first direction.

An apparatus for manufacturing a light diffusion unit in accordance with other exemplary embodiments of the present invention includes a convex-concave extruder and an extending unit. The convex-concave extruder extrudes a material to form a diffusion plate having a plurality of protrusions. An outlet of the convex-concave extruder has a convex-concave pattern to form the protrusions on the diffusion plate. The extending unit extends the diffusion plate in a first direction.

The convex-concave roller includes a prism roller, a polygonal roller, etc. The convex-concave extruder includes a prism extruder, a polygonal extruder, etc.

An exemplary embodiment of a method of maintaining a diffusion plate in a display device in a flat configuration having a light entering surface and a light exiting surface forming substantially planar surfaces in the diffusion plate includes providing a diffusion plate including a material deformable by at least one of heat and moisture, exposing the diffusion plate to at least one of heat and moisture, and providing a deformation compensation means on the diffusion plate including one of a protruded portion on an end portion of the diffusion plate enabling an increased deformation of a central portion of the diffusion plate due to gravity, a deformation preventing layer having a lower water absorption than a remaining portion of the diffusion plate, and an increased surface area on the light entering surface of the diffusion plate.

According to exemplary embodiments of the present invention, the light diffusion unit has a convex shape toward a lower surface of the display device to compensate for additional deformation of the diffusion plate, caused by heat and moisture. Therefore, the diffusion plate in the display device is prevented from having a convex shape toward an upper surface of the display device.

### BRIEF DESCRIPTION OF THE DRAWINGS

The above and other advantages of the present invention will become more apparent by describing in detailed exemplary embodiments thereof with reference to the accompanying drawings, in which:

FIG. 1 is a cross-sectional view showing an exemplary embodiment of a light diffusion unit in accordance with the present invention;

FIG. 2 is a plan view showing an exemplary rear surface of the light diffusion unit shown in FIG. 1;

FIG. 3 is a cross-sectional view showing an exemplary embodiment of a display device having the light diffusion unit shown in FIG. 1;

FIG. 4 is a cross-sectional view showing another exemplary embodiment of a light diffusion unit in accordance with the present invention;

FIG. 5 is a perspective view showing the light diffusion unit shown in FIG. 4;

FIG. 6 is a cross-sectional view showing another exemplary embodiment of a light diffusion unit in accordance with the present invention;

FIG. 7 is a cross-sectional view showing another exemplary embodiment of a light diffusion unit in accordance with the present invention;

FIG. 8 is a cross-sectional view showing another exemplary embodiment of a light diffusion unit in accordance with the present invention;

FIG. 9 is a cross-sectional view showing another exemplary embodiment of a light diffusion unit in accordance with the present invention;

FIG. 10 is a cross-sectional view showing an exemplary embodiment of a display device having the light diffusion unit shown in FIG. 7;

FIG. 11 is a cross-sectional view showing an exemplary embodiment of an apparatus for manufacturing a light diffusion unit shown in FIG. 4;

FIG. 12 is a cross-sectional view showing another exemplary embodiment of an apparatus for manufacturing a light diffusion unit in accordance with the present invention; and

FIG. 13 is a perspective view showing an exemplary outlet of an extruder shown in FIG. 12.

### DETAILED DESCRIPTION OF THE INVENTION

It should be understood that the exemplary embodiments of the present invention described below may be varied and modified in many different ways without departing from the inventive principles disclosed herein, and the scope of the present invention is therefore not limited to these particular following embodiments. Rather, these embodiments are provided so that this disclosure will be through and complete, and will fully convey the concept of the invention to those skilled in the art by way of example and not of limitation.

Hereinafter, the present invention will be described in detail with reference to the accompanying drawings. In the drawings, the thickness of layers, films, and regions are exaggerated for clarity. Like numerals refer to like elements throughout. It will be understood that when an element such as a layer, film, region, or substrate is referred to as being “on” another element, it can be directly on the other element or intervening elements may also be present.

FIG. 1 is a cross-sectional view showing an exemplary embodiment of a light diffusion unit in accordance with the present invention.

Referring to FIG. 1, the light diffusion unit 104 includes a diffusion plate 110 and a protruded portion 150. Alternatively, the light diffusion unit 104 may instead include a plurality of protruded portions 150, such as a plurality of protruded portions 150 arranged evenly or otherwise along the periphery of the light diffusion unit 104.

The diffusion plate 110 includes a lower surface 111, an upper surface 112, and a plurality of side surfaces 113. The upper surface 112 corresponds to the lower surface 111, such as arranged opposite to the lower surface 111. In an undeformed state, the upper surface 112 may be substantially parallel to the lower surface 111. The side surfaces 113 connect the lower surface 111 to the upper surface 112. A light is incident into the lower surface 111, and the diffusion plate 110 diffuses the light. The diffused light exits the upper surface 112. Thus, the lower surface 111 is a light-entering surface and the upper surface 112 is a light exiting surface of the diffusion plate 110. In this exemplary embodiment, the diffusion plate 110 contains polymethylmethacrylate (“PMMA”).

The protruded portion 150, or alternatively each of the protruded portions 150, is protruded from the lower surface 111 of the diffusion plate 110 by a predetermined height adjacent side surfaces 113. The protruded portions 150 are integrally formed with the diffusion plate 110. A first thickness t3 of a central portion CP of the light diffusion unit 104 is smaller than a second thickness t4 of an end portion EP of the light diffusion unit 104 because the protruded portion 150 adds extra thickness to the diffusion plate 110 in the areas where it occurs. While described as integrally formed, it would also be within the scope of these embodiments to separately apply protruded portion 150 to the peripheral edges of the lower surface 111.

When the light diffusion unit 104 is substantially perpendicular to a gravitational direction GD, the protruded portions 150 guide the central portion CP of the diffusion plate 110 to form a convex shape toward the gravitational direction GD by a weight of the diffusion plate 110. That is, the central portion CP of the diffusion plate 110 has a downwardly convex shape. In other words, the central portion CP of the diffusion plate 110 sags downwardly by a weight of the diffusion plate 110, and thus the central portion CP of the diffusion plate 110 is located further from an LCD panel than end portions EP of the diffusion plate 110. The added thickness provided by the protrusions 150 exaggerates an amount of deformation of the central portion CP to an appropriate amount equivalent to an anticipated amount of deformation to be experienced by the diffusion plate 110 as a result of heat and moisture, as will be further described below.

When the lower surface 111 is exposed to heat and moisture, the diffusion plate 110 is additionally deformed. An amount of shrinkage of the lower surface 111 is greater than that of the upper surface 112 so that the diffusion plate 110 is changed from the convex shape into a flat shape. Therefore, the deformation of the diffusion plate 110 is compensated by additional deformation formed by the heat and the moisture. The deformation due to gravity in the gravitational direction substantially cancels out the deformation due to heat and moisture in a direction towards the LCD panel such that the resultant diffusion plate retains a substantially flat condition with substantially planar upper and lower surfaces 112, 111.

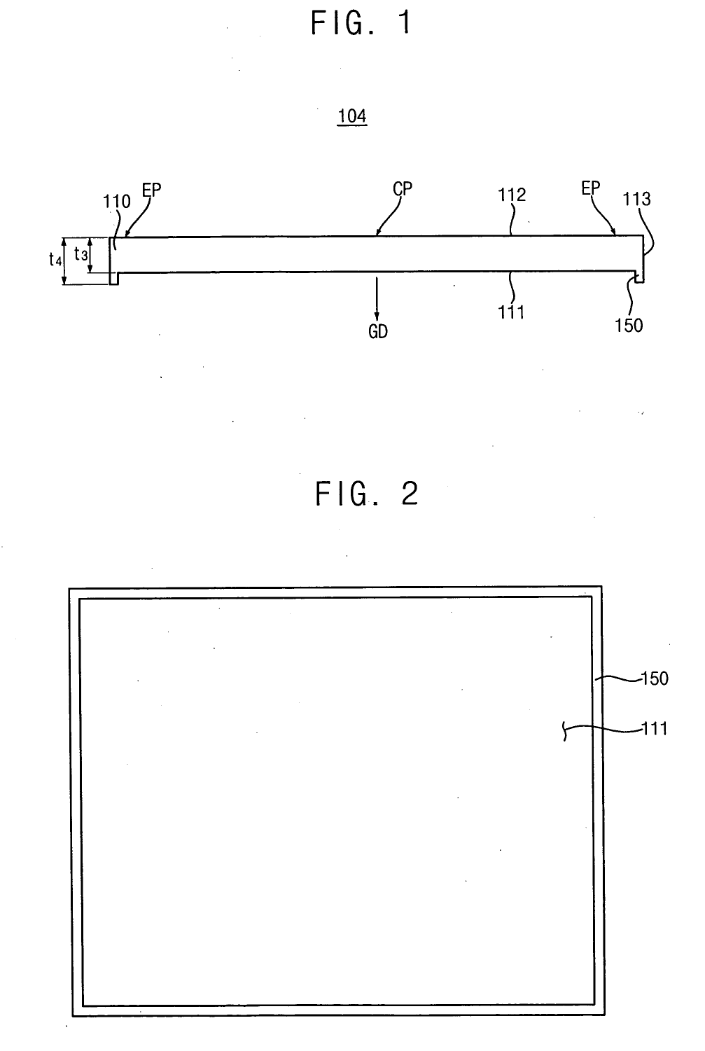

The protruded portions 150 may be protruded from corners of the diffusion plate 110 toward the lower surface 111 so as to compensate the deformation of the diffusion plate 110. That is, while the protruded portion 150 is illustrated in FIG. 2 as being provided along the entire peripheral edge of the lower surface 111, protruded portions 150 may instead be provided only in corners of the lower surface 111. In other exemplary embodiments, the protruded portions 150 may be scattered about varying locations along the peripheral edges of the lower surface 111 for allowing the central portion CP of the diffusion plate 110 to sag a desired amount due to gravity in order to compensate for an anticipated deformation due to heat and/or moisture in the opposite direction.

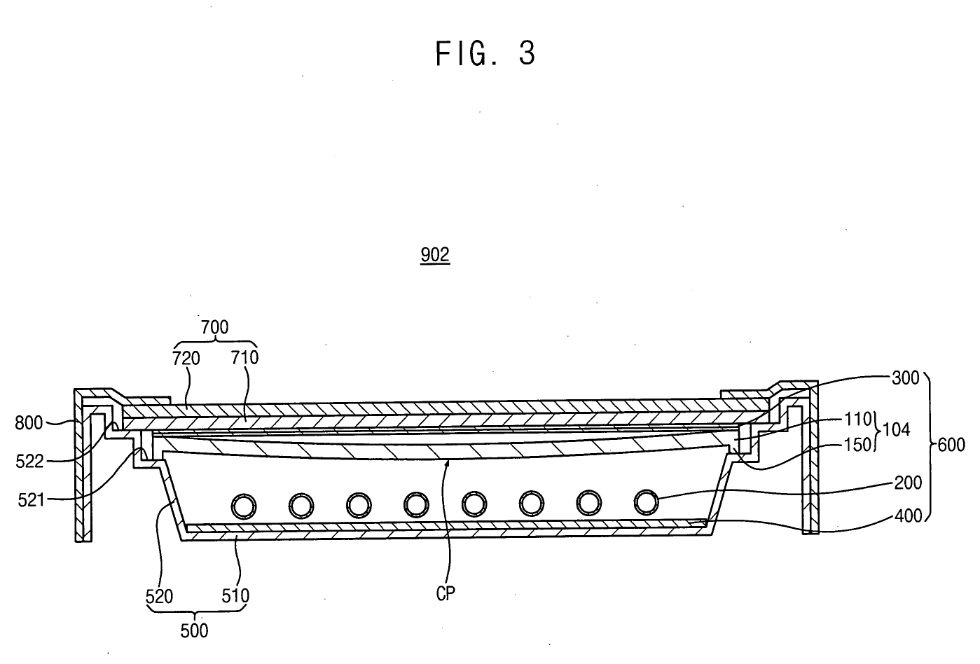

FIG. 3 is a cross-sectional view showing an exemplary embodiment of a display device having the light diffusion unit shown in FIG. 1.

Referring to FIG. 3, the display device 902 includes a backlight assembly 600 that generates a light and a display panel 700 positioned on the backlight assembly 600. The display panel 700 displays an image using the light from the backlight assembly 600.

The display panel 700 includes a first substrate 710, a second substrate 720, and a liquid crystal layer (not shown). The second substrate 720 corresponds to the first substrate 710. The liquid crystal layer is interposed between the first and second substrates 710 and 720. The first substrate 710 includes a plurality of thin film transistors (“TFTs”) (not shown) and a plurality of pixel electrodes (not shown) that are arranged in a matrix shape. The second substrate 720 includes a color filter layer (not shown) and a common electrode (not shown) that corresponds to the pixel electrodes. Light having predetermined wavelengths may pass through the color filter layer.

The backlight assembly 600 includes a plurality of lamps 200, the light diffusion unit 104, optical sheets 300, reflecting plate 400, and a receiving container 500.

The lamps 200 are arranged substantially parallel to one another to generate the light. The light diffusion unit 104 is positioned over the lamps 200 to diffuse the light generated from the lamps 200 to uniformize the luminance of the light.

The optical sheets 300 are arranged on the light diffusion unit 104 to improve a viewing angle and a luminance of a viewer's side of the diffused light. Any number of optical sheets 300, and optical sheets 300 having varying light affecting properties would be within the scope of these embodiments. The light that has passed through the optical sheets 300 is incident into the display panel 700. The light diffusion unit 104 has a flat shape so that the optical sheets 300 that are on the light diffusion unit 104 may not be deformed, thereby improving an image display quality of the display device 902.

The reflecting plate 400 is positioned under the lamps 200. A portion of the light generated from the lamps 200 is reflected from the reflecting plate 400 toward the light diffusion unit 104, thereby improving the luminance of the backlight assembly 600.

The receiving container 500 includes a bottom plate 510 and a plurality of sidewalls 520 that are protruded from sides of the bottom plate 510 to define a receiving space therein. The reflecting plate 400 and the lamps 200 are received in the receiving space. Each of the sidewalls 520 has a first stepped portion 521 and a second stepped portion 522.

The light diffusion unit 104 rests upon the first stepped portion 521. The first stepped portion 521 makes contact with the protruded portion or portions 150 that are formed on the end portion EP of the light diffusion unit 104. Therefore, the central portion CP of the diffusion plate 110 that is on the first stepped portion 521 forms the convex shape toward the gravitational direction GD by the weight of the diffusion plate 110. When the height of the protruded portions 150 is increased, the central portion CP of the diffusion plate is more downwardly convexed. Therefore, a degree of the central portion CP of the diffusion plate to be downwardly convexed is controlled by the height of the protruded portion or portions 150.

When the lower surface 111 of the diffusion plate 110 is exposed to heat generated from the lamps 200 and moisture that is provided from an exterior of the backlight assembly 600, the deformation of the diffusion plate 110 due to gravity in a gravitational direction is compensated by additional deformation in an opposite direction caused by heat and moisture so that the diffusion plate 110 returns to or maintains the flat shape, such as by having substantially planar upper and lower surfaces 112, 111. Therefore, the luminance of the light that has passed through the diffusion plate 110 is uniformized, and the deformation of the optical sheets 300 on the light diffusion unit 104 is prevented, thereby improving the image display quality.

The optical sheets 300 are provided on the light diffusion unit 104. The display panel 700 is arranged on the optical sheets 300. End portions of the display panel 700 are supported on the second stepped portion 522 of the receiving container 500.

The display device 902 further includes a covering member 800 that is combined with the receiving container 500. The covering member 800 presses the end portions of the display panel 700 to fix the display panel 700 to the receiving container 500.

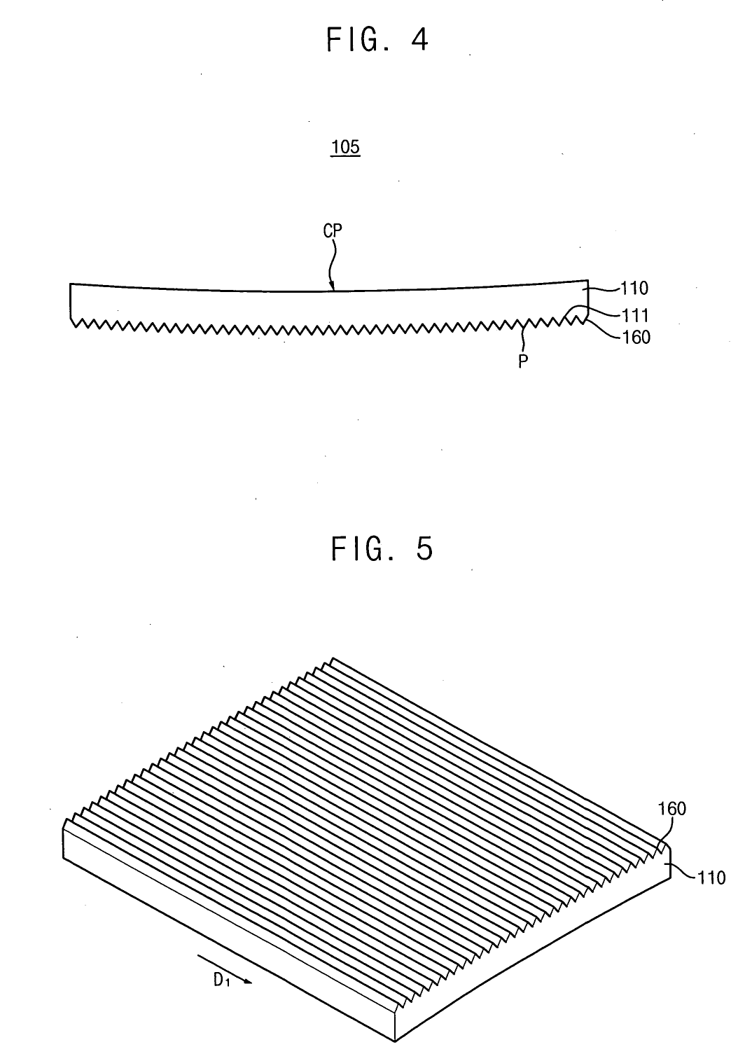

FIG. 4 is a cross-sectional view showing another exemplary embodiment of a light diffusion unit in accordance with the present invention. FIG. 5 is a perspective view showing the light diffusion unit shown in FIG. 4.

Referring to FIGS. 4 and 5, the light diffusion unit 105 includes a diffusion plate 110 and a plurality of protrusions 160. The protrusions 160 are formed on the lower surface 111 of the diffusion plate 110 to increase a surface area of the lower surface 111. In this exemplary embodiment, each of the protrusions 160 has a prism shape that is extended in a first direction D₁. In the illustrated embodiment, each protrusion 160 is longitudinally arranged so as to be parallel to adjacent protrusions 160. The protrusions 160 may be arranged such that longitudinal axes of the protrusions 160 are parallel to a first pair of opposite side surfaces 113 and perpendicular to a second pair of opposite side surfaces 113.

The diffusion plate 110 absorbs moisture that is provided from an exterior of a backlight assembly, and also absorbs heat generated from lamps irradiated onto a lower surface 111 of the diffusion plate 110 so that the lower surface 111 of the diffusion plate 110 shrinks. The surface area of the lower surface 111 of the diffusion plate 110 is increased by the protrusions 160 to prevent a deformation of the diffusion plate 110 although the lower surface 111 of the diffusion plate 110 is exposed to the moisture and the heat. Since the diffusion plate 110 does not require a large deformation due to gravity to compensate for a deformation due to heat and moisture, the light diffusion unit 105 of FIGS. 4 and 5 need not include the protruded portions 150, although it would be within the scope of these embodiments to include both protruded portions 150 and protrusions 160 within a diffusion plate 110.

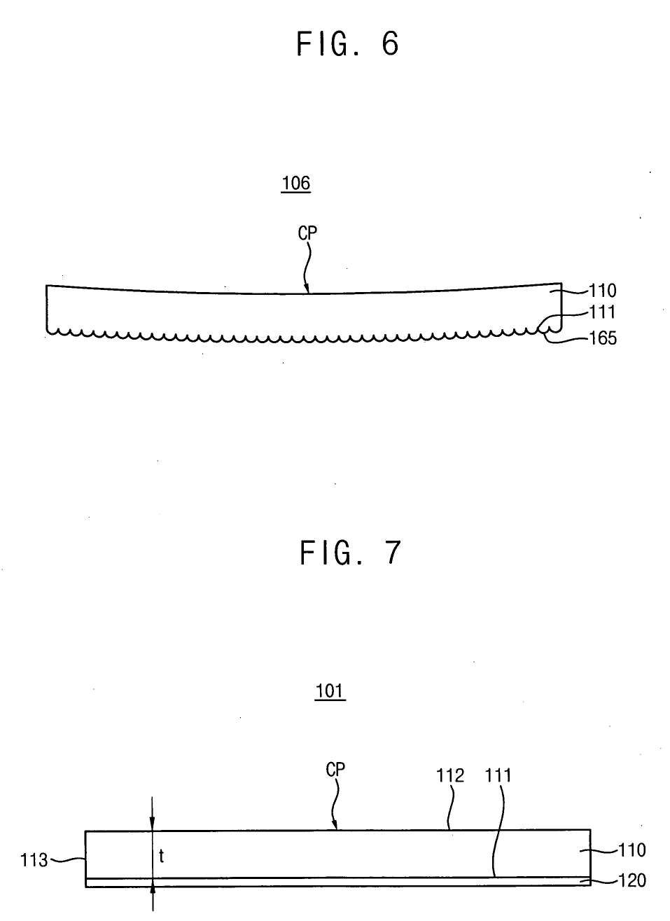

FIG. 6 is a cross-sectional view showing another exemplary embodiment of a light diffusion unit in accordance with the present invention.

Referring to FIG. 6, a corner of each of the protrusions 165 of the light diffusion unit 106 has a rounded shape.

Alternatively, a cross-section of each of the protrusions 165 may have a semicircular shape, a polygonal shape, etc. Also, in yet another alternative embodiment, each of the protrusions 165 may be extended in a direction that is different from a first direction D₁. In any case, the embodiments described with respect to FIG. 6 include protrusions 165 that increase a surface area of the lower surface 111 to prevent a deformation of the diffusion plate 110 that would otherwise be caused by heat and moisture.

FIG. 7 is a cross-sectional view showing another exemplary embodiment of a light diffusion unit in accordance with the present invention.

Referring to FIG. 7, the light diffusion unit 101 includes a diffusion plate 110 and a deformation preventing layer 120.

The diffusion plate 110 includes a lower surface 111, an upper surface 112, and a plurality of side surfaces 113. As illustrated, the diffusion plate 110 has a quadrangular plate shape, although other shapes would be within the scope of these embodiments. The upper surface 112 corresponds to the lower surface 111. The side surfaces 113 connect the lower surface 111 to the upper surface 112. A light is incident into the lower surface 111, and the diffusion plate 110 diffuses the light. The diffused light exits the upper surface 112.

In this exemplary embodiment, the diffusion plate 110 contains PMMA. A thickness ‘t’ of the diffusion plate 110 is about 0.5 mm to about 2 mm.

The deformation preventing layer 120 has lower water absorption than the diffusion plate 110. The deformation preventing layer 120 is attached to the lower surface 111 of the diffusion plate 110.

In this exemplary embodiment, the deformation preventing layer 120 contains, by example only, a styrene based copolymer, a polyethyleneterephthalate (“PET”) based copolymer, a polycarbonate (“PC”) based resin, a cycloolefin polymer, cycloolefin copolymer, etc. Since the deformation preventing layer 120 is less likely to deform due to moisture, the deformation preventing layer 120 attached to the diffusion plate 110 helps prevent the diffusion plate 110 from deforming due to moisture.

The light diffusion unit 101 forms a convex shape toward a gravitational direction GD by a difference between a shrinkage of the deformation preventing layer 120 and a shrinkage of the diffusion plate 110. When the light diffusion unit 101 having the convex shape is exposed to heat or moisture, the deformation of the light diffusion unit 101 is compensated by additional deformation caused by the heat and the moisture so that the light diffusion unit 101 returns to or maintains a flat shape. Therefore, the light diffusion unit 101 has the deformation preventing layer 120 to compensate the deformation of a central portion CP of the diffusion plate 110, and the protruded portions 150 are not necessary with this embodiment for providing an adequate compensation of deformation due to heat and moisture, although providing both the protruded portions 150 and the deformation preventing layer 120 would be within the scope of these embodiments.

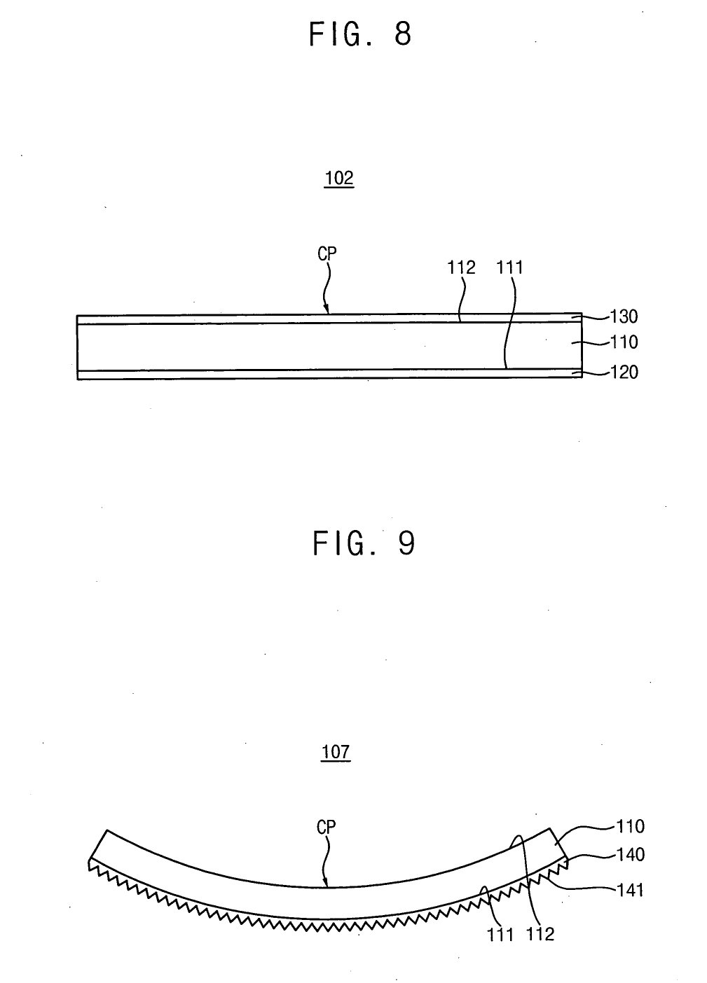

FIG. 8 is a cross-sectional view showing another exemplary embodiment of a light diffusion unit in accordance with the present invention.

Referring to FIG. 8, the light diffusion unit 102 includes a diffusion plate 110, a first deformation preventing layer 120 that is substantially the same as the deformation preventing layer of FIG. 7 and a second deformation preventing layer 130. The second deformation preventing layer 130 may be an auxiliary deformation preventing layer 130. The first and second deformation preventing layers 120 and 130 have lower water absorption than the diffusion plate 110. The first and second deformation preventing layers 120 and 130 are attached to a lower surface 111 and an upper surface 112 of the diffusion plate 110, respectively. In this exemplary embodiment, each of the first and second deformation preventing layers 120 and 130 contains, for example, a styrene based copolymer, a PET based copolymer, a PC based copolymer, a cycloolefin polymer, a cycloolefin copolymer, etc.

Therefore, the light diffusion unit 102 has the first and second deformation preventing layers 120 and 130 to compensate the deformation of a central portion CP of the diffusion plate 110.

FIG. 9 is a cross-sectional view showing another exemplary embodiment of a light diffusion unit in accordance with the present invention.

Referring to FIG. 9, the light diffusion unit 107 includes a diffusion plate 110, a deformation preventing layer 140, and a plurality of protrusions 141.

The deformation preventing layer 140 has lower water absorption than the diffusion plate 110. The deformation preventing layer 140 is attached to a lower surface 111 of the diffusion plate 110.

The protrusions 141 are formed on the deformation preventing layer 140 to increase a surface area of the deformation preventing layer 140. In this exemplary embodiment, each of the protrusions 141 has a prism shape. When the surface area of the deformation preventing layer 140 is increased, the light diffusion unit 107 may be easily bent toward a gravitational direction GD. Thus, in this example, protrusions 141 are used for deforming the light diffusion unit 107 due to gravity instead of the protruding portions 150, although, it would also be possible to include both the protruding portions 150 and the protrusions 141.

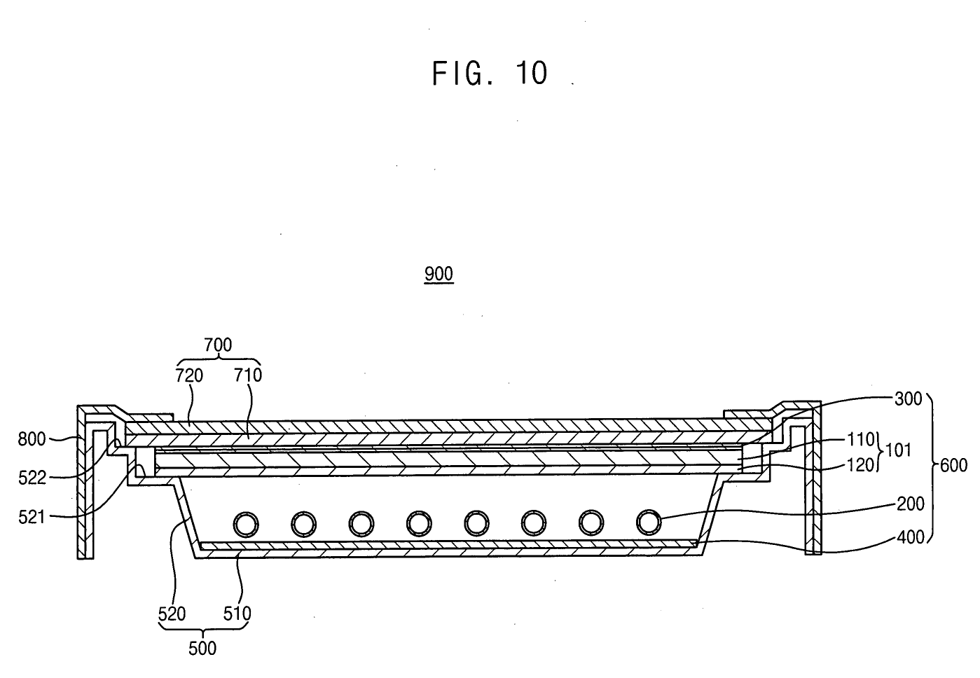

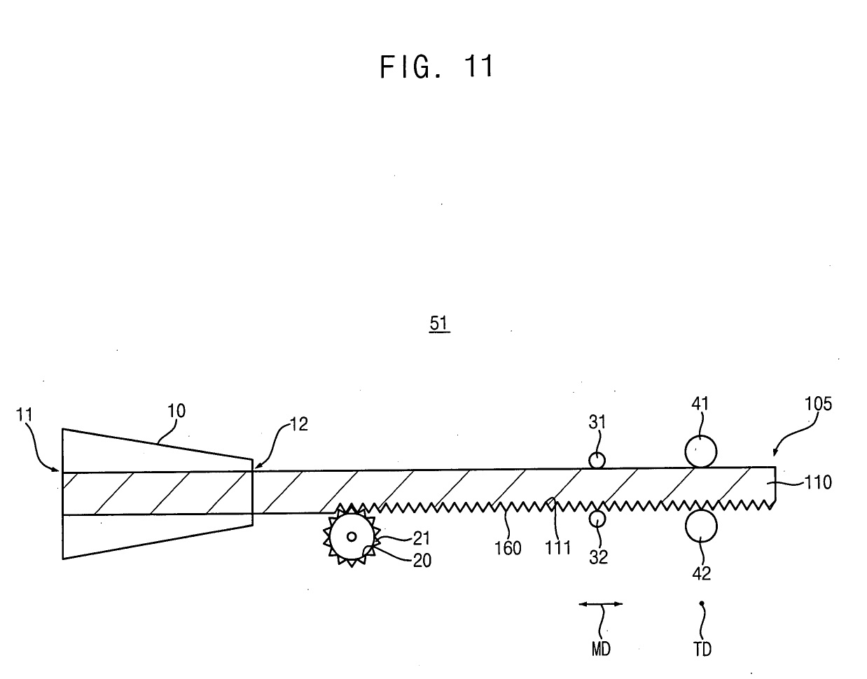

FIG. 10 is a cross-sectional view showing an exemplary embodiment of a display device having the light diffusion unit shown in FIG. 7.

Referring to FIG. 10, the display device 900 includes a backlight assembly 600, a display panel 700, and a covering member 800. The backlight assembly 600 provides the display panel 700 with a light. The display panel 700 is on the backlight assembly 600 to display an image using the light. The backlight assembly 600 includes a plurality of lamps 200, a light diffusion unit 101, optical sheets 300, a reflecting plate 400, and a receiving container 500.

The lamps 200 are arranged substantially parallel to one another to generate a light. The light diffusion unit 101 is on the lamps 200 to diffuse the light generated from the lamps 200.

The optical sheets 300 are on the light diffusion unit 101 to improve a viewing angle and a luminance of a viewer's side of the diffused light. The light that has passed through the optical sheets 300 is incident into the display panel 700.

The light diffusion unit 101 is arranged on a first stepped portion 521 of the receiving container 500, and the optical sheets 300 are positioned on the light diffusion unit 101. The display panel 700 is on the optical sheets 300, and end portions of the display panel 700 are supported on a second stepped portion 522 of the receiving container 500.

The light diffusion unit 101 forms a convex shape toward a gravitational direction GD by a difference between a shrinkage of the deformation preventing layer 120 and a shrinkage of the diffusion plate 110. When the light diffusion unit 101 having a convex shape is exposed to a heat generated from the lamps 200 or a moisture from an exterior of the display device 900, the deformation of the light diffusion unit 101 is compensated by additional deformation formed by the heat and the moisture so that the light diffusion unit 101 returns to and maintains a flat shape. Therefore, the light diffusion unit 101 has the deformation preventing layer 120 to compensate the deformation of a central portion CP of the diffusion plate 110.

When the lower surface 111 of the diffusion plate 110 is exposed to heat generated from the lamps 200 and moisture provided from the exterior of the backlight assembly 600, the deformation of the diffusion plate 110 is compensated by additional deformation formed by the heat and the moisture so that the diffusion plate 110 has the flat shape. In addition, a deformation of the optical sheets 300 is prevented to improve an image display quality of the display device 900.

FIG. 11 is a cross-sectional view showing an exemplary embodiment of an apparatus for manufacturing a light diffusion unit 105 shown in FIG. 4.

Referring to FIG. 11, the apparatus 51 for manufacturing the light diffusion unit includes an extruder 10, a prism roller 20, a first extension roller 31, a second extension roller 32, a third extension roller 41, and a fourth extension roller 42. A material, such as one containing PMMA, for forming a diffusion plate 110 is injected into the extruder 10 through an inlet 11 of the extruder 10 and then extruded through an outlet 12 of the extruder 10. The material may first be heated to a necessary temperature in order to effectively pass it through the extruder 10.

A prism pattern 21 is formed on an outer surface of the prism roller 20. The prism roller 20 is adjacent to the outlet 12 of the extruder 10. The prism roller 20 may have a same width as a width of the diffusion plate 110, for forming prism-shaped protrusions that extend from one end of the diffusion plate 110 to an opposite end of the diffusion plate 110. The prism roller 20 rotates under a lower surface 111 of the diffusion plate 110 extruded from the extruder 10 so that a plurality of protrusions 160 having a prism shape is formed on the lower surface 111 of the diffusion plate 110.

The first and second extension rollers 31 and 32 are on an upper surface and the lower surface 111 of the diffusion plate 110 having the protrusions 160. The diffusion plate 110 having the protrusions 160 is extended in a first direction MD between the first and second extension rollers 31 and 32.

The third and fourth extension rollers 41 and 42 are positioned in a downstream position of the first and second extension rollers 31 and 32. The third and fourth extension rollers 41 and 42 are on the upper surface and the lower surface 111 of the diffusion plate 110 that is extended in the first direction MD by the first and second extension rollers 31 and 32 to extend the diffusion plate 110 that is extended in the first direction MD in a second direction TD that is substantially perpendicular to the first direction MD.

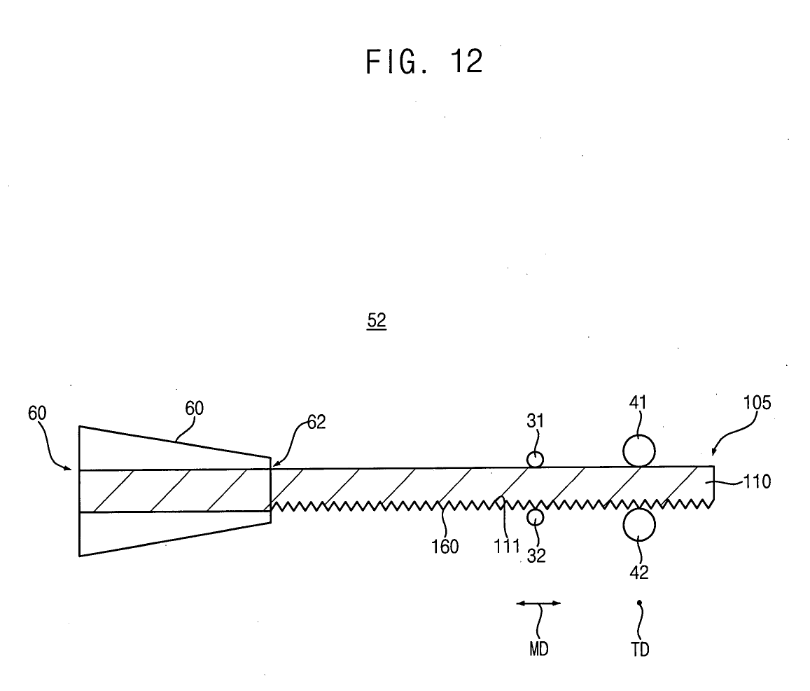

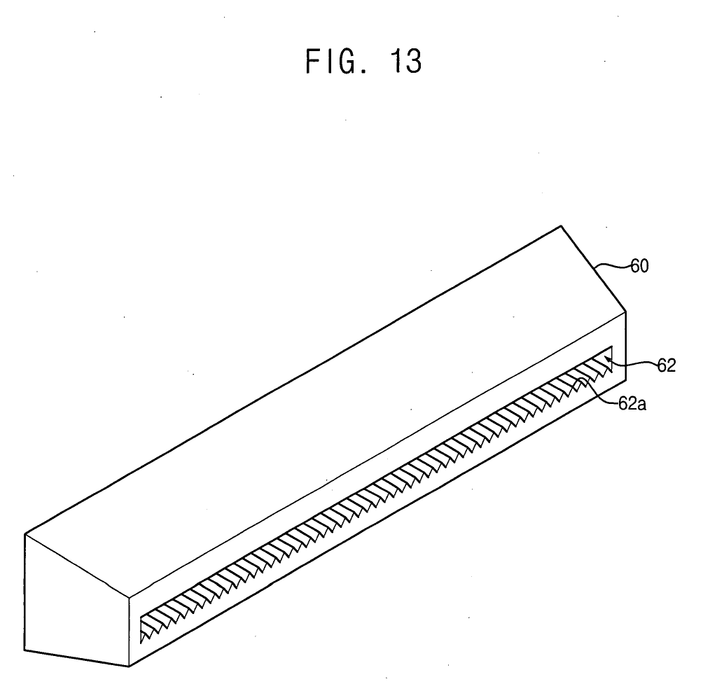

FIG. 12 is a cross-sectional view showing another exemplary embodiment of an apparatus for manufacturing a light diffusion unit in accordance with the present invention. FIG. 13 is a perspective view showing an outlet of an extruder shown in FIG. 12.

Referring to FIGS. 12 and 13, the apparatus 52 for manufacturing the light diffusion unit, such as light diffusion unit 105 includes a prism extruder 60, a first extension roller 31, a second extension roller 32, a third extension roller 41, and a fourth extension roller 42. A material for forming a diffusion plate 110, such as one including PMMA, is injected into the prism extruder 60 through an inlet 61 of the prism extruder 60 and is then extruded through an outlet 62 of the prism extruder 60. The outlet 62 has a prism pattern 62a to form a plurality of protrusions 160 on the diffusion plate 110. Thus, this embodiment eliminates the need for the prism roller 20 as in the prior embodiment.

The first and second extension rollers 31 and 32 are on an upper surface and a lower surface of the extruded diffusion plate 110 having the protrusions 160. The diffusion plate 110 having the protrusions 160 is extended in a first direction MD between the first and second extension rollers 31 and 32.

The third and fourth extension rollers 41 and 42 are on the upper surface and the lower surface of the diffusion plate 110 that is extended in the first direction MD by the first and second extension rollers 31 and 32 to extend the diffusion plate 110 that is extended in the first direction MD in a second direction TD that is substantially perpendicular to the first direction MD.

According to the present invention, the light diffusion unit has a convex shape toward a lower surface of the display device to compensate additional deformation of the diffusion plate, which is formed by heat from lamps of a backlight assembly and moisture from an exterior of the backlight assembly. Therefore, the diffusion plate in the display device maintains or returns to a flat shape. A method for maintaining a flat shape of the diffusion plate is also made possible using the above described embodiments for compensating for deformation due to heat and moisture.

Therefore, the luminance of the light exiting the light diffusion unit is uniformized, and the deformation of the optical sheets is prevented, thereby improving an image display quality.

This invention has been described with reference to the exemplary embodiments. It is evident, however, that many alternative modifications and variations will be apparent to those having skill in the art in light of the foregoing description. Accordingly, the present invention embraces all such alternative modifications and variations as fall within the spirit and scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A light diffusion unit comprising:
a diffusion plate having a light diffusion material that diffuses a light; and
a protruded portion on the diffusion plate to guide the light diffusion unit so that a central portion of the diffusion plate has a convex shape.

2. The light diffusion unit of claim 1, wherein the diffusion plate comprises a polymethylmethacrylate based resin.

3. The light diffusion unit of claim 1, wherein the protruded portion is protruded from an end portion of a lower surface of the diffusion plate to form a downwardly convex shape by a weight of the diffusion plate.

4. The light diffusion unit of claim 3, wherein the diffusion plate has a first thickness at a central portion of the diffusion plate and a second thickness on the end portion including the protruded portion, the second thickness greater than the first thickness.

5. The light diffusion unit of claim 3, wherein the protruded portion extends along a periphery of the lower surface.

6. The light diffusion unit of claim 3, wherein the protruded portion is integrally formed with the diffusion plate.

7. The light diffusion unit of claim 1, wherein the protruded portion comprises a plurality of protrusions to increase a surface area of a lower surface of the diffusion plate.

8. The light diffusion unit of claim 7, wherein the plurality of protrusions are longitudinally arranged and parallel to each other.

9. The light diffusion unit of claim 7, wherein each of the protrusions comprises a prism shape.

10. The light diffusion unit of claim 7, wherein a corner of each of the protrusions is rounded.

11. The light diffusion unit of claim 1, wherein the light diffusion material in the diffusion plate is deformable by heat or moisture, and when the material is affected by heat or moisture, the diffusion plate deforms in a direction opposite the convex shape to form a flat shape for the diffusion plate.

12. A light diffusion unit comprising:
a diffusion plate having a light diffusion material that diffuses a light; and
a first deformation preventing layer formed under the diffusion plate, the first deformation preventing layer compensating a deformation of a central portion of the diffusion plate.

13. The light diffusion unit of claim 12, wherein the diffusion plate comprises polymethylmethacrylate, and the first deformation preventing layer has a lower water absorption than the diffusion plate.

14. The light diffusion unit of claim 13, wherein the first deformation preventing layer comprises at least one selected from the group consisting of a styrene based copolymer, a polyethylene terephthalate based copolymer, a polycarbonate based resin, a cycloolefin based polymer and a cycloolefin based copolymer.

15. The light diffusion unit of claim 12, the first deformation preventing layer further comprises a plurality of protrusions formed on the first deformation preventing layer to increase a surface area of the first deformation preventing layer.

16. The light diffusion unit of claim 15, each of the protrusions comprises a prism shape.

17. The light diffusion unit of claim 12, further comprising a second deformation preventing layer on the diffusion plate, the second deformation preventing layer having a lower water absorption than the diffusion plate to compensate a deformation of a central portion of the diffusion plate.

18. The light diffusion unit of claim 17, wherein the second deformation preventing layer comprises at least one selected from the group consisting of a styrene based copolymer, a polyethylene terephthalate based copolymer, a polycarbonate based resin, a cycloolefin based polymer and a cycloolefin based copolymer.

19. The light diffusion unit of claim 12, wherein a thickness of the diffusion plate is about 0.5 mm to about 2 mm.

20. The light diffusion unit of claim 12, wherein the first deformation preventing layer maintains the diffusion plate in a flat shape when the diffusion plate is exposed to moisture.

21. A display device comprising:
a lamp for generating a light;
a light diffusion unit that includes a diffusion plate having a light diffusion material that diffuses the light generated from the lamp, and a protruded portion on the diffusion plate to guide the light diffusion unit so that a central portion of the diffusion plate has a convex shape, the light diffusion unit being on the lamp; and
a display panel on the light diffusion unit to display an image using the light that has passed through the light diffusion unit.

22. The display device of claim 21, wherein the protruded portion is protruded from an end portion of a lower surface of the diffusion plate, and the protruded portion is integrally formed with the diffusion plate.

23. The display device of claim 22, further comprising a receiving container that receives the lamp, wherein the protruded portion makes contact with the receiving container to support the diffusion plate, and a central portion of the diffusion plate forms a convex shape toward a lower surface of the display device by a weight of the diffusion plate.

24. The display device of claim 23, wherein the light diffusion material of the diffusion plate is deformable by heat or moisture, and when the diffusion plate is exposed to heat or moisture, the diffusion plate is deformed in an opposite direction of the convex shape to form a a flat shape for the diffusion plate.

25. The display device of claim 21, wherein the protruded portion comprises a plurality of protrusions formed under the diffusion plate, and each of the protrusions has a prism shape.

26. A display device comprising:
a lamp for generating a light;
a light diffusion unit that includes a diffusion plate having a light diffusion material that diffuses the light generated from the lamp, and a first deformation preventing layer formed on a light entering surface of the diffusion plate, the first deformation preventing layer compensating a deformation of a central portion of the diffusion plate, the light diffusion unit being on the lamp; and
a display panel on the light diffusion unit to display an image using the light that has passed through the light diffusion unit.

27. The display device of claim 26, wherein the diffusion plate comprises polymethylmethacrylate, and the first deformation preventing layer comprises at least one selected from the group consisting of a styrene based copolymer, a polyethylene terephthalate based copolymer, a polycarbonate based resin, a cycloolefin based polymer and a cycloolefin based copolymer.

28. The display device of claim 26, wherein the first deformation preventing layer comprises a plurality of protrusions to increase a surface area of a lower surface of the first deformation preventing layer, and each of the protrusions has a prism shape.

29. The display device of claim 26, further comprising a second deformation preventing layer on the diffusion plate, the second deformation preventing layer having a lower water absorption than the diffusion plate to compensate a deformation of a central portion of the diffusion plate.

30. The display device of claim 26, the first deformation preventing layer having a lower water absorption than a remaining portion of the diffusion plate.

31. An apparatus for manufacturing a light diffusion unit, the apparatus comprising:
an extruder that extrudes a material to form a diffusion plate;
a convex-concave roller adjacent to an outlet of the extruder to form a plurality of protrusions on the diffusion plate; and
an extending unit that extends the diffusion plate in a first direction.

32. The apparatus of claim 31, wherein the convex-concave roller comprises a prism pattern having a plurality of prisms, and the convex-concave roller is on a lower surface of the diffusion plate to form a plurality of protrusions on the lower surface of the diffusion plate having a prism shape.

33. The apparatus of claim 31, wherein the extending unit comprises:
a first extension roller that extends the diffusion plate in the first direction; and
a second extension roller that extends the diffusion plate in a second direction that is substantially perpendicular to the first direction.

34. An apparatus for manufacturing a light diffusion unit, the apparatus comprising:
a convex-concave extruder that extrudes a material to form a diffusion plate having a plurality of protrusions, an outlet of the convex-concave extruder having a convex-concave pattern to form the protrusions on the diffusion plate; and
an extending unit that extends the diffusion plate in a first direction.

35. The apparatus of claim 34, wherein the convex-concave pattern of the convex-concave extruder comprises a prism pattern, and each of the protrusions of the diffusion plate has a prism shape.

36. A method of maintaining a diffusion plate in a display device in a flat configuration having a light entering surface and a light exiting surface forming substantially planar surfaces in the diffusion plate, the method comprising:
providing a diffusion plate including a material deformable by at least one of heat and moisture;
exposing the diffusion plate to at least one of heat and moisture; and
providing a deformation compensation means on the diffusion plate including one of a protruded portion on an end portion of the diffusion plate enabling an increased deformation of a central portion of the diffusion plate due to gravity, a deformation preventing layer having a lower water absorption than a remaining portion of the diffusion plate, and an increased surface area on the light entering surface of the diffusion plate.
